(19) United States
(12) Patent Application Publication
(10) Pub. No.: US 2025/0308453 A1
(43) Pub. Date: Oct. 2, 2025

(54) PIXEL CIRCUIT, DRIVING METHOD AND DISPLAY PANEL

(71) Applicant: SEEYA OPTRONICS CO., LTD., Shanghai (CN)

(72) Inventors: Ping-lin LIU, Shanghai (CN); Tong WU, Shanghai (CN)

(73) Assignee: SEEYA OPTRONICS CO., LTD., Shanghai (CN)

(21) Appl. No.: 19/089,339

(22) Filed: Mar. 25, 2025

(30) Foreign Application Priority Data
Apr. 1, 2024 (CN) 202410387650.X

(51) Int. Cl. G09G 3/3233

(52) U.S. Cl. CPC G09G 3/3233; G09G 2300/0819; G09G 2300/0842; G09G 2300/0861; G09G 2310/08; G09G 2320/0233

(57) ABSTRACT

A pixel circuit includes a negative feedback module, a drive module, a data writing module, a threshold compensation module and a storage capacitor. The negative feedback module is connected between a first power terminal and a first terminal of the drive module, and a control terminal of the negative feedback module is connected to the first terminal of the drive module. A second terminal of the drive module is connected to a light-emitting element. The data writing module is connected between a data signal terminal and a first terminal of the storage capacitor, a control terminal of the data writing module is connected to a first scanning terminal, and a second terminal of the storage capacitor is connected to a control terminal of the drive module. The threshold compensation module is connected between the control terminal of the drive module and a second terminal of the drive module.

### CROSS-REFERENCE TO RELATED APPLICATION

This application claims priority to Chinese Patent Application No. 202410387650.X, filed on Apr. 1, 2024, the disclosure of which is incorporated herein by reference in its entirety.

### TECHNICAL FIELD

The present disclosure relates to the field of display technology and, in particular, to a pixel circuit, a driving method and a display panel.

### BACKGROUND

With the continuous development of electronic technology, the demand for the display effect of a display screen has been getting higher and higher.

The organic light-emitting diode (OLED) screen has attracted widespread attention and gradually become a representative of the next generation of display screens due to advantages such as self-luminescence, low power consumption, thinness and lightness, flexibility, vibrant colors, high contrast and fast response rate. A corresponding pixel circuit needs to be disposed in the OLED screen, thereby providing a light emission drive signal for OLED components and enabling the OLED components to emit light.

However, based on a current pixel circuit, the OLED screen has the problems such as non-uniform display.

### SUMMARY

The present disclosure provides a pixel circuit, a driving method and a display panel to solve the problem of non-uniform display in an existing OLED screen.

According to an aspect of the present disclosure, a pixel circuit is provided. The pixel circuit includes a negative feedback module, a drive module, a data writing module, a threshold compensation module and a storage capacitor.

The negative feedback module is connected between a first power terminal and a first terminal of the drive module, and a control terminal of the negative feedback module is connected to the first terminal of the drive module.

A second terminal of the drive module is connected to a light-emitting element for providing a light emission drive signal to the light-emitting element, and the drive module includes a drive transistor.

The data writing module is connected between a data signal terminal and a first terminal of the storage capacitor, a control terminal of the data writing module is connected to a first scanning terminal, and a second terminal of the storage capacitor is connected to a control terminal of the drive module.

The threshold compensation module is connected between the control terminal of the drive module and a second terminal of the drive module, and a control terminal of the threshold compensation module is connected to a second scanning terminal.

A working process of the pixel circuit includes at least a pre-stage and a light emission stage, and the pre-stage includes a threshold compensation stage.

At the threshold compensation stage, the drive module, the data writing module and the threshold compensation module are turned on, and the negative feedback module is turned off.

At the light emission stage, the negative feedback module and the drive module are turned on, and the data writing module and the threshold compensation module are turned off.

According to another aspect of the present disclosure, a driving method of a pixel circuit is provided and applied to the pixel circuit described above. The working process of the pixel circuit includes at least the pre-stage and the light emission stage, and the pre-stage includes the threshold compensation stage.

The driving method includes the steps described below.

At the threshold compensation stage, the drive module, the data writing module and the threshold compensation module are turned on, and the negative feedback module is turned off.

At the light emission stage, the negative feedback module and the drive module are turned on, and the data writing module and the threshold compensation module are turned off.

According to another aspect of the present disclosure, a display panel is provided. The display panel includes the pixel circuit described above.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

To illustrate solutions of embodiments of the present disclosure more clearly, drawings used in description of embodiments of the present disclosure are described hereinafter. Apparently, these drawings illustrate part of embodiments of the present disclosure. Those of ordinary skill in the art may obtain other drawings based on these drawings on the premise that no creative work is done.

FIG. 1 is a schematic diagram of a pixel circuit according to an embodiment of the present disclosure.

FIG. 2 is a schematic diagram of the pixel circuit shown in FIG. 1 at a threshold compensation stage.

FIG. 3 is a schematic diagram of the pixel circuit shown in FIG. 1 at a light emission stage.

FIG. 4 is a schematic diagram of another pixel circuit according to an embodiment of the present disclosure.

FIG. 5 is a schematic diagram of another pixel circuit according to an embodiment of the present disclosure.

FIG. 6 is a schematic diagram of another pixel circuit according to an embodiment of the present disclosure.

FIG. 7 is a schematic diagram of another pixel circuit according to an embodiment of the present disclosure.

FIG. 8 is a timing diagram of the pixel circuit shown in FIG. 7.

FIG. 9 is a schematic diagram of a conventional pixel circuit.

FIG. 10 is a schematic diagram illustrating the simulation results of two different pixel circuits.

FIG. 11 illustrates a driving method of a pixel circuit according to an embodiment of the present disclosure.

### DETAILED DESCRIPTION

For a better understanding of solutions of the present disclosure by those skilled in the art, solutions in embodiments of the present disclosure are described clearly and completely hereinafter in conjunction with the drawings in embodiments of the present disclosure. Apparently, the embodiments described hereinafter are part, not all, of embodiments of the present disclosure. Based on embodiments of the present disclosure, all other embodiments obtained by those of ordinary skill in the art on the premise that no creative work is done are within the scope of the present disclosure.

It is to be noted that the terms “first”, “second” and the like in the description, claims and drawings of the present disclosure are used to distinguish between similar objects and are not necessarily used to describe a particular order or sequence. It is to be understood that the data used in this way is interchangeable where appropriate so that embodiments of the present disclosure described herein may also be implemented in a sequence not illustrated or described herein. Additionally, terms “include” and “have” and any variations thereof are intended to encompass a non-exclusive inclusion. For example, a process, method, system, product, or device that includes a series of steps or units not only includes the expressly listed steps or units but may also include other steps or units that are not expressly listed or are inherent to such process, method, product, or device.

At present, the resolution of a display panel is getting higher and higher, the size of a corresponding pixel circuit is getting smaller and smaller, and the capacitance value of a capacitor in the pixel circuit is also getting smaller and smaller. When a control signal of the pixel circuit is inverted from low to high, an effect of charge injection is relatively apparent.

In an embodiment, the pixel circuit includes multiple transistors. When signal hopping occurs at a control terminal of a certain transistor, for example, when a signal of the control terminal of the transistor is shifted from a high level to a low level or from a low level to a high level, a source and a drain of the transistor are also prone to level hopping (a tiny capacitance is formed between the control terminal of the transistor and the source or the drain of the transistor), resulting in a change in potentials of some nodes in the pixel circuit, which is equivalent to injecting charges into the nodes.

Providing a scan signal to a control terminal of a certain transistor in a pixel circuit is used as an example. When a scan signal line provides a scan signal to pixel circuits at different positions, a difference exists between the voltage values of the scan signal provided by the scan signal line at a near end and a far end. Therefore, the same nodes of a pixel circuit at the far end and a pixel circuit at the near end have different charge injection amounts, resulting in different light emission currents of the pixel circuits for finally driving light-emitting elements, an offset in the brightness of the light-emitting elements at the far end and the near end and poorer display uniformity of the display panel. Here, the near end refers to an end facing a driver circuit of the display panel, and the far end refers to an end facing away from the driver circuit of the display panel. Generally, various types of driver circuits such as a data driving circuit and a scan driving circuit are disposed at one end of the display panel. From a direction close to the driver circuit to a direction away from the driver circuit, for each pixel circuit, a difference exists in voltage values of the same scan signal.

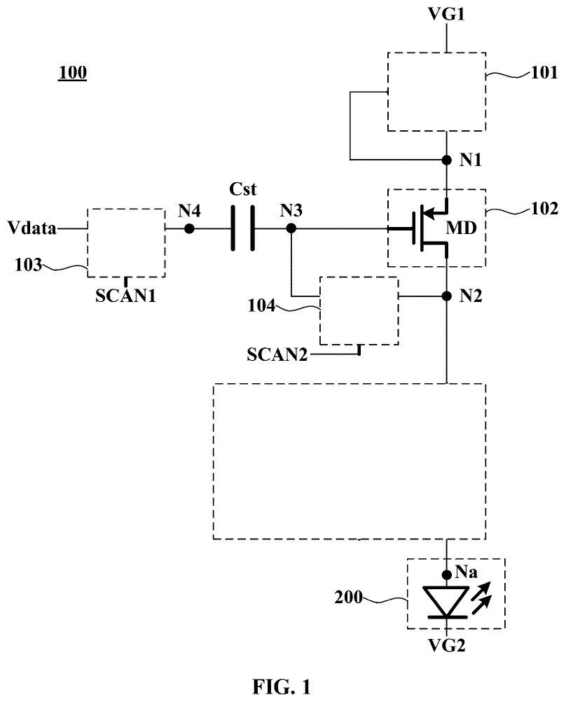

Embodiments of the present disclosure provide a pixel circuit to solve the problem in the related art. FIG. 1 is a schematic diagram of a pixel circuit according to an embodiment of the present disclosure. As shown in FIG. 1, a pixel circuit 100 includes a negative feedback module 101, a drive module 102, a data writing module 103, a threshold compensation module 104 and a storage capacitor Cst; the negative feedback module 101 is connected between a first power terminal VG1 and a first terminal N1 of the drive module 102, and a control terminal of the negative feedback module 101 is connected to the first terminal N1 of the drive module 102; a second terminal N2 of the drive module 102 is connected to a light-emitting element 200 for providing a light emission drive signal to the light-emitting element 200, and the drive module 102 includes a drive transistor MD; the data writing module 103 is connected between a data signal terminal Vdata and a first terminal of the storage capacitor Cst, a control terminal of the data writing module 103 is connected to a first scanning terminal SCAN1, and a second terminal of the storage capacitor Cst is connected to a control terminal N3 of the drive module 102; the threshold compensation module 104 is connected between the control terminal N3 of the drive module 102 and a second terminal N2 of the drive module 102, and a control terminal of the threshold compensation module 104 is connected to a second scanning terminal SCAN2; a working process of the pixel circuit 100 includes at least a pre-stage and a light emission stage, and the pre-stage includes a threshold compensation stage; at the threshold compensation stage, the drive module 102, the data writing module 103 and the threshold compensation module 104 are turned on, and the negative feedback module 101 is turned off; at the light-emission stage, the negative feedback module 101 and the drive module 102 are turned on, and the data writing module 103 and the threshold compensation module 104 are turned off.

In this embodiment, the pixel circuit 100 includes the negative feedback module 101. The control terminal of the negative feedback module 101 is connected to the first terminal N1 of the drive module 102, a first terminal (or an input terminal) of the negative feedback module 101 is connected to the first power terminal VG1, and a second terminal (or an output terminal) of the negative feedback module 101 is connected to the first terminal N1 of the drive module 102. Signal hopping at the first terminal N1 of the drive module 102 can control the on or off state of the negative feedback module 101, that is, a transmission path between the first terminal of the negative feedback module 101 and the second terminal of the negative feedback module 101 is controlled to be connected or disconnected. When a signal of the first terminal N1 of the drive module 102 controls the negative feedback module 101 to be turned on, a signal provided by the first power terminal VG1 is written to the second terminal of the negative feedback module 101, that is, the first terminal N1 of the drive module 102, via the first terminal of the negative feedback module 101. When the signal of the first terminal N1 of the drive module 102 controls the negative feedback module 101 to be turned off, a transmission path between the first power terminal VG1 and the first terminal N1 of the drive module 102 is disconnected. Optionally, the signal of the first power terminal VG1 is a PVDD power signal provided by the display panel to the pixel circuit 100. When a potential of the first terminal N1 of the drive module 102 is a valid control signal, the negative feedback module 101 is driven to be turned on. When the potential of the first terminal N1 of the drive module 102 is an invalid control signal, the negative feedback module 101 is driven to be turned off.

The pixel circuit 100 includes the drive module 102. The drive module 102 includes the first terminal N1 (or an input terminal), the second terminal N2 (or an output terminal) and the control terminal N3. The first terminal N1 of the drive module 102 is connected to the second terminal of the negative feedback module 101, and the second terminal N2 of the drive module 102 is connected to the light-emitting element 200. Signal hopping at the control terminal N3 of the drive module 102 can control the on or off state of the drive module 102, that is, a transmission path between the first terminal N1 of the drive module 102 and the second terminal N2 of the drive module 102 is controlled to be connected or disconnected. In an embodiment, the second terminal N2 of the drive module 102 is connected to a first electrode Na of the light-emitting element 200, and other modules of the pixel circuit 100 are connected in series between the second terminal N2 of the drive module 102 and the first electrode Na of the light-emitting element 200 and specifically described one by one in subsequent embodiments. A second electrode of the light-emitting element 200 is connected to a second power terminal VG2. Optionally, a signal of the second power terminal VG2 is a PVEE power signal provided by the display panel to the pixel circuit 100, and a voltage of the PVDD power signal is greater than a voltage of the PVEE power signal. Optionally, the first electrode Na of the light-emitting element 200 is an anode, and the second electrode of the light-emitting element 200 is a cathode. However, optionally, the first electrode of the light-emitting element is a cathode and the second electrode of the light-emitting element is an anode in other embodiments according to requirements of products. The drive module 102 includes the drive transistor MD, and the control terminal N3 of the drive module 102 is a gate of the drive transistor MD. When a potential of the control terminal N3 of the drive module 102 is a valid control signal, the drive module 102 is controlled to be turned on. When the potential of the control terminal N3 of the drive module 102 is an invalid control signal, the drive module 102 is controlled to be turned off.

The pixel circuit 100 includes the data writing module 103, the threshold compensation module 104 and the storage capacitor Cst. The control terminal of the data writing module 103 is connected to the first scanning terminal SCAN1, a first terminal (or an input terminal) of the data writing module 103 is connected to the data signal terminal Vdata, a second terminal (or an output terminal) of the data writing module 103 is connected to the first terminal N4 of the storage capacitor Cst, and the second terminal of the storage capacitor Cst is connected to the control terminal N3 of the drive module 102, that is, the second terminal (N4) of the data writing module 103 is connected to the control terminal N3 of the drive module 102 via the storage capacitor Cst. Signal hopping at the first scanning terminal SCAN1 can control the on or off state of the data writing module 103, that is, a transmission path between the first terminal of the data writing module 103 and the second terminal of the data writing module 103 is controlled to be connected or disconnected. The control terminal of the threshold compensation module 104 is connected to the second scanning terminal SCAN2, a first terminal of the threshold compensation module 104 is connected to the control terminal N3 of the drive module 102, and a second terminal of the threshold compensation module 104 is connected to the second terminal N2 of the drive module 102. Signal hopping at the second scanning terminal SCAN2 can control the on or off state of the threshold compensation module 104, that is, a transmission path between the first terminal (N3) of the threshold compensation module 104 and the second terminal (N2) of the threshold compensation module 104 is controlled to be connected or disconnected. When the first scanning terminal SCAN1 provides a valid scan signal, the data writing module 103 is controlled to be turned on. When the first scanning terminal SCAN1 provides an invalid scan signal, the data writing module 103 is controlled to be turned off. When the second scanning terminal SCAN2 provides a valid scan signal, the threshold compensation module 104 is controlled to be turned on. When the second scanning terminal SCAN2 provides an invalid scan signal, the threshold compensation module 104 is controlled to be turned off.

As described above, the pixel circuit 100 includes only one storage capacitor Cst. Therefore, a relatively small size of the pixel circuit 100 is conducive to improving a resolution and applicable to making a high-resolution display panel. In addition, if the pixel circuit includes at least two capacitors, the size of the pixel circuit is gradually decreased according to a requirement of the display panel for an increasing resolution, resulting in a gradually increased difference amount caused by variables of the at least two capacitors in the pixel circuit. In this embodiment, the pixel circuit 100 only includes one storage capacitor Cst. The high-resolution display panel is satisfied, and an effect of an additional difference between two capacitors in the pixel circuit caused by a process or a layout in the high-resolution display panel can also be avoided, thereby improving the reliability and stability of the display panel and further improving a display effect.

The working process of the pixel circuit 100 includes at least the pre-stage and the light emission stage, and the pre-stage includes the threshold compensation stage. The pre-stage of the pixel circuit 100 may also be understood as a non-light emission stage, and the non-light emission stage of the pixel circuit 100 includes at least the threshold compensation stage for performing threshold compensation on the drive transistor MD. At the pre-stage, a transmission path between the first power terminal VG1 and the light-emitting element 200 is disconnected, and the drive module 102 provides no light emission drive signal to the light-emitting element 200. At the light emission stage, the transmission path between the first power terminal VG1 and the light-emitting element 200 is connected, the drive module 102 is turned on, the signal provided by the first power terminal VG1 flows into the light-emitting element 200 via the drive module 102, that is, a connected path is formed between the first power terminal VG1, the drive module 102, the light-emitting element 200 and the second power terminal VG2 so that the drive module 102 provides the light emission drive signal to the light-emitting element 200 and based on these, the light-emitting element 200 generates a light emission current and emits light.

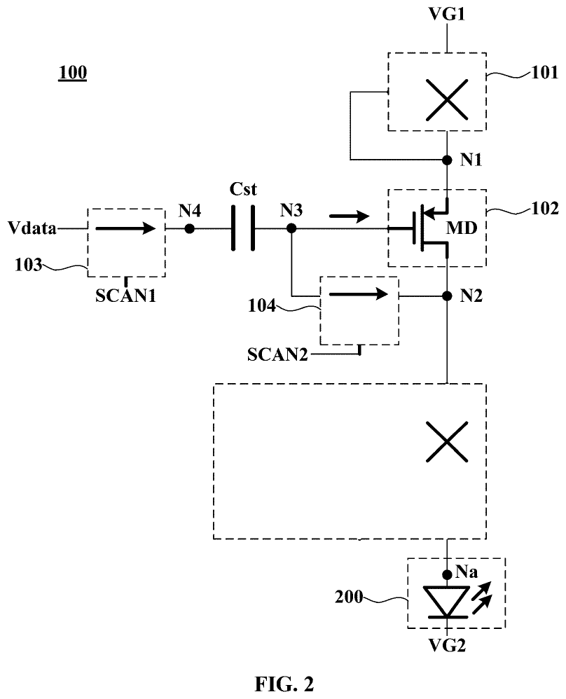

FIG. 2 is a schematic diagram of the pixel circuit shown in FIG. 1 at a threshold compensation stage. As shown in FIG. 2, at the threshold compensation stage, the first scanning terminal SCAN1 provides a valid scan signal to turn on the data writing module 103, and the second scanning terminal SCAN2 provides a valid scan signal to turn on the threshold compensation module 104 and the drive module 102. The negative feedback module 101 is turned off, and a transmission path between the second terminal N2 of the drive module 102 and the first electrode Na of the light-emitting element 200 is disconnected so that the transmission path between the first power terminal VG1 and the light-emitting element 200 is disconnected. Therefore, the signal provided by the first power terminal VG1 cannot flow into the light-emitting element 200 via the drive module 102, and the pixel circuit 100 is at the non-light emission stage. A signal (V_{DATA}) provided by the data signal terminal Vdata is written to the first terminal N4 of the storage capacitor Cst via the data writing module 103. Therefore, a potential of a node N4 is a reference potential V_{DATA}. A potential of a node N3 is equal to a potential of a node N2 and is equal to (V_{N1a}−Vₜₕₚ), where V_{N1a} is a potential of a node N1 at a current stage, and Vₜₕₚ is a threshold voltage of the drive transistor MD.

When both the signals provided by the first scanning terminal SCAN1 and the second scanning terminal SCAN2 hops from valid scan signals to invalid scan signals, both the data writing module 103 and the threshold compensation module 104 are turned off and, simultaneously, an additional charge amount (ΔVx) is injected into the node N4, the node N3 and the node N2. Charge injection simultaneously occurs at the first terminal N4 and the second terminal N3 of the storage capacitor Cst and a second terminal N2 of the drive transistor MD so that the effect of charge injection is weakened. The potential of the node N3 is (V_{N1a}−Vₜₕₚ+ΔVx×Cst/(Cst+Cot)), the potential of the node N2 is equal to the potential of the node N3, and the potential of the node N4 is V_{DATA}+ΔVx, where Cot is a total capacitance generated by a capacitor network formed by the nodes N3 and N4 except for the storage capacitor Cst, ΔVx is the charge amount injected into the node N4, the node N3 and the node N2, and Cst also represents a capacitance of the storage capacitor Cst. Thus, although the additional charge amount ΔVx is still injected into the node N3 via the storage capacitor Cst, the effect of charge injection is significantly weakened due to the simultaneous actions of the node N3 and the node N4 so that the captured threshold voltage of the drive transistor MD is closer to an actual threshold voltage and threshold voltages captured in pixel circuits 100 at different positions in the display panel tend to be consistent, thereby more effectively implementing a threshold voltage compensation function for the pixel circuit 100 in the display panel.

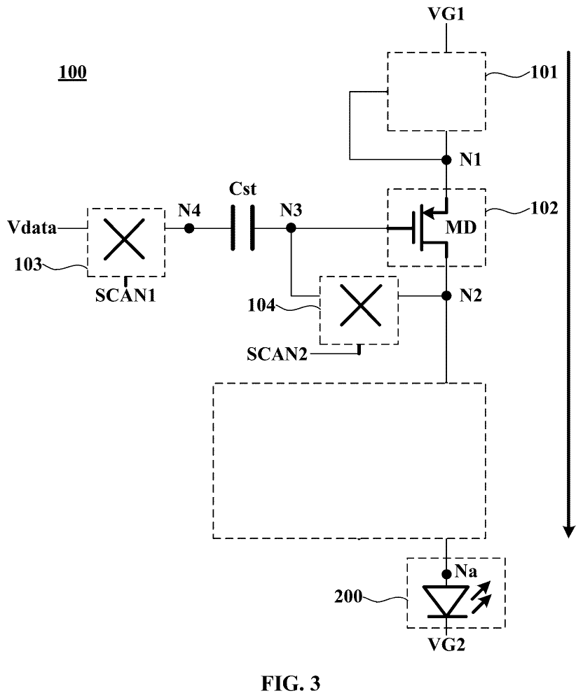

FIG. 3 is a schematic diagram of the pixel circuit shown in FIG. 1 at a light emission stage. As shown in FIG. 3, at the light emission stage, the negative feedback module 101 and the drive module 102 are turned on, and the data writing module 103 and the threshold compensation module 104 are turned off so that a transmission path between the first power terminal VG1 and the first electrode Na of the light-emitting element 200 is connected, that is, the connected path is formed between the first power terminal VG1, the drive module 102, the light-emitting element 200 and the second power terminal VG2. Therefore, the signal provided by the first power terminal VG1 flows into the light-emitting element 200 via the drive module 102, the light-emitting element 200 emits light, and the pixel circuit 100 is at the light emission stage. At the light emission stage, both the first terminal N4 and the second terminal N3 of the storage capacitor Cst are at a fixed potential. In this case, the storage capacitor Cst is not susceptible to a noise. Therefore, a floating state of the second terminal N3 of the storage capacitor Cst, that is, the control terminal N3 of the drive module 102, is reduced, and an offset noise (also referred to as random offset) of a control terminal N3 of the drive transistor MD is relatively low. In addition, the negative feedback module 101 has the effect of suppressing a current change caused by a voltage fluctuation. Based on these, an offset noise of the pixel circuit 100 is relatively low, thereby effectively improving display uniformity.

In the present disclosure, the pixel circuit includes the negative feedback module and one storage capacitor. The negative feedback module is connected between the first power terminal and the first terminal of the drive module, and the control terminal of the negative feedback module is connected to the first terminal of the drive module. The first terminal of the storage capacitor is connected to the data writing module, and the second terminal of the storage capacitor is connected to the control terminal of the drive module. At the threshold compensation stage, the negative feedback module is turned off. At the light emission stage, the data writing module and the threshold compensation module are turned off. In the present disclosure, the pixel circuit includes only one storage capacitor. Therefore, a relatively small size of the pixel circuit is conducive to improving the resolution and applicable to making the high-resolution display panel. At the threshold compensation stage, charge injection simultaneously occurs at the first terminal and the second terminal of the storage capacitor and the second terminal of the drive module so that the effect of charge injection can be weakened and the threshold voltage of the drive transistor of the pixel circuit can be closer to the actual threshold voltage, thereby effectively implementing the threshold voltage compensation function. At the light emission stage, both the first terminal and the second terminal of the storage capacitor are at the fixed potential and not susceptible to the noise. The negative feedback module has the effect of suppressing the current change caused by the voltage fluctuation. Based on these, the display uniformity can be effectively improved.

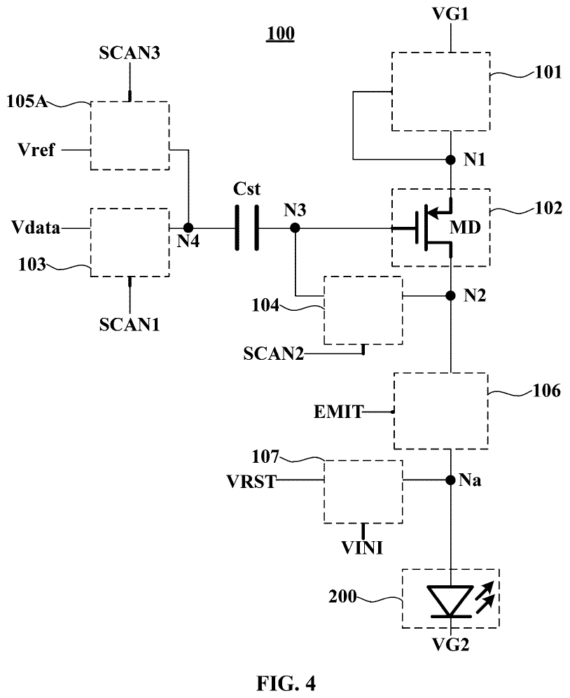

FIG. 4 is a schematic diagram of another pixel circuit according to an embodiment of the present disclosure. As shown in FIG. 4, optionally, the pixel circuit 100 further includes a first reset module 105A. The first reset module 105A is connected between a first reset signal terminal Vref and the first terminal N4 of the storage capacitor Cst, and a control terminal of the first reset module 105A is connected to a third scanning terminal SCAN3. Optionally, the pixel circuit 100 further includes a light emission control module 106 and a second reset module 107. The light emission control module 106 is connected between the second terminal N2 of the drive module 102 and the first electrode Na of the light-emitting element 200, and a control terminal of the light emission control module 106 is connected to a dimming control terminal EMIT. The second reset module 107 is connected between a second reset signal terminal VRST and the first electrode Na of the light-emitting element 200, and a control terminal of the second reset module 107 is connected to a reset control terminal VINI.

As shown in FIG. 4, a first terminal (or an input terminal) of the first reset module 105A is connected to the first reset signal terminal Vref, and a second terminal (or an output terminal) of the first reset module 105A is connected to the first terminal N4 of the storage capacitor Cst. The signal hopping provided by the third scanning terminal SCAN3 can control the on or off state of the first reset module 105A so that a transmission path between the first terminal and the second terminal of the first reset module 105A is connected or disconnected. When the third scanning terminal SCAN3 provides a valid scan signal, the first reset module 105A is controlled to be turned on. When the third scanning terminal SCAN3 provides an invalid scan signal, the first reset module 105A is controlled to be turned off.

A first terminal (or an input terminal) of the light emission control module 106 is connected to the second terminal N2 of the drive module 102, a second terminal (or an output terminal) of the light emission control module 106 is connected to the first electrode Na of the light-emitting element 200, and the control terminal of the light emission control module 106 is connected to the dimming control terminal EMIT. Signal hopping provided by the dimming control terminal EMIT can control the on or off state of the light emission control module 106 so that a transmission path between the first terminal N2 and the second terminal Na of the light emission control module 106 is connected or disconnected. When the dimming control terminal EMIT provides a valid control signal, the light emission control module 106 is driven to be turned on. When the dimming control terminal EMIT provides an invalid control signal, the light emission control module 106 is driven to be turned off.

A first terminal (or an input terminal) of the second reset module 107 is connected to the second reset signal terminal VRST, a second terminal (or an output terminal) of the second reset module 107 is connected to the first electrode Na of the light-emitting element 200, and the control terminal of the second reset module 107 is connected to the reset control terminal VINI. The signal hopping provided by the reset control terminal VINI can control the on or off state of the second reset module 107 so that a transmission path between the first terminal and the second terminal Na of the second reset module 107 is connected or disconnected. When the reset control terminal VINI provides a valid control signal, the second reset module 107 is controlled to be turned on. When the reset control terminal VINI provides an invalid control signal, the second reset module 107 is controlled to be turned off.

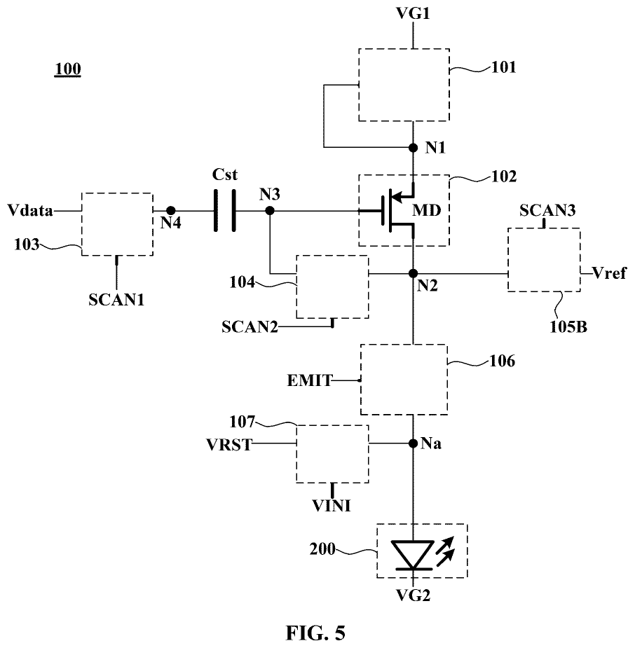

FIG. 5 is a schematic diagram of another pixel circuit according to an embodiment of the present disclosure. The connection of a first reset module of the pixel circuit 100 in FIG. 5 is different from the connection of the first reset module in FIG. 4. In an embodiment, the pixel circuit 100 in FIG. 5 includes a first reset module 105B. The first reset module 105B is connected between the first reset signal terminal Vref and the second terminal N2 of the drive module 102, and a control terminal of the first reset module 105B is connected to the third scanning terminal SCAN3.

For the pixel circuit 100 shown in FIG. 4 or 5, for example, at the threshold compensation stage, the third scanning terminal SCAN3 provides an invalid scan signal to turn off the first reset module 105A/105B, the dimming control terminal EMIT provides an invalid control signal to turn off the light emission control module 106, and the reset control terminal VINI provides an invalid control signal to turn off the second reset module 107. At the light emission stage, the dimming control terminal EMIT provides a valid control signal to turn on the light emission control module 106, the third scanning terminal SCAN3 provides an invalid scan signal to turn off the first reset module 105A/105B, and the reset control terminal VINI provides an invalid control signal to turn off the second reset module 107.

The pre-stage of the pixel circuit 100 further includes an initialization stage different from the threshold compensation stage. At the initialization stage, the third scanning terminal SCAN3 provides an invalid scan signal to turn off the first reset module 105A/105B, the dimming control terminal EMIT provides a valid control signal turn on the light emission control module 106, and the reset control terminal VINI provides a valid control signal to turn on the second reset module 107. Moreover, the drive module 102, the data writing module 103 and the threshold compensation module 104 are all controlled to be turned on, and the negative feedback module 101 is controlled to be turned off.

The pre-stage of the pixel circuit 100 further includes a pre-light emission stage different from the threshold compensation stage. At the pre-light emission stage, the third scanning terminal SCAN3 provides an invalid scan signal to turn on the first reset module 105A/105B, the dimming control terminal EMIT provides a valid control signal to turn on the light emission control module 106, and the reset control terminal VINI provides a valid control signal to turn on the second reset module 107. Moreover, both the negative feedback module 101 and the drive module 102 are turned on, and both the data writing module 103 and the threshold compensation module 104 are turned off.

It is to be noted that for the case where the pre-stage of the pixel circuit 100 includes the initialization stage, the threshold compensation stage and the pre-light emission stage, optionally, the initialization stage is performed before the threshold compensation stage and the pre-light emission stage is performed after the threshold compensation stage.

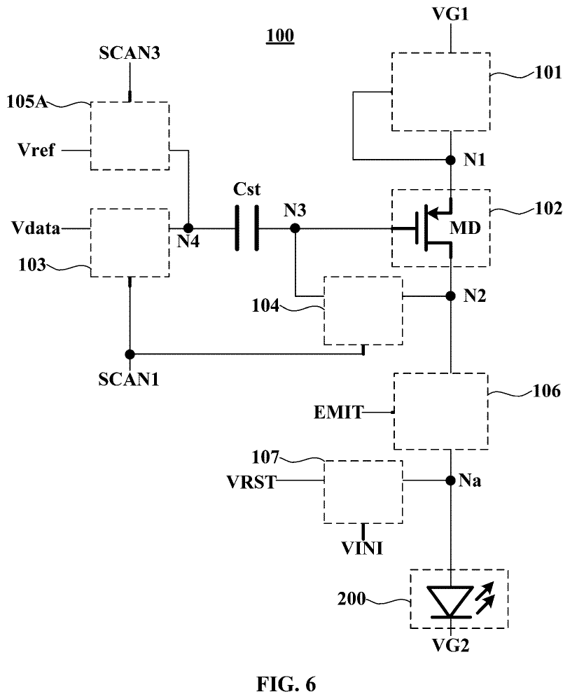

Optionally, the first scanning terminal and the second scanning terminal are connected to the same scan signal line. FIG. 6 is a schematic diagram of another pixel circuit according to an embodiment of the present disclosure. As shown in FIG. 6, optionally, when the first scanning terminal SCAN1 and the second scanning terminal SCAN2 are connected to the same scan signal line, the data writing module 103 and the threshold compensation module 104 are both turned on or both turned off. If the data writing module 103 and the threshold compensation module 104 are both turned on, the signal provided by the data signal terminal Vdata is written to the first terminal N4 of the storage capacitor Cst via the data writing module 103. If the data writing module 103 and the threshold compensation module 104 are both turned off, the first terminal N4 of the storage capacitor Cst is in a floating state, and the first terminal N4 and the second terminal N3 of the storage capacitor Cst are stable at the fixed potential, thereby reducing the offset noise of the pixel circuit 100.

In addition, the first scanning terminal SCAN1 and the second scanning terminal SCAN2 are connected to the same scan signal line so that the number of connected signal lines in the pixel circuit 100 can also be reduced, thereby facilitating the implementation of a narrow bezel.

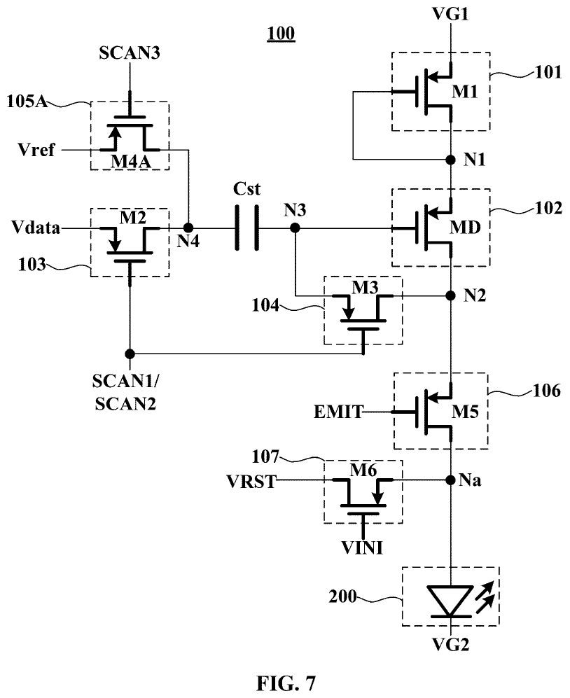

FIG. 7 is a schematic diagram of another pixel circuit according to an embodiment of the present disclosure and a structure diagram of the pixel circuit shown in FIG. 6. As shown in FIG. 7, optionally, the negative feedback module 101 includes a first transistor M1, the data writing module 103 includes a second transistor M2, and the threshold compensation module 104 includes a third transistor M3. A first terminal of the first transistor M1 is connected to the first power terminal VG1, and a gate of the first transistor M1 and a second terminal of the first transistor M1 are both connected to a first terminal N1 of the drive transistor MD. A gate of the second transistor M2 is connected to the first scanning terminal SCAN1, a first terminal of the second transistor M2 is connected to the data signal terminal Vdata, and a second terminal of the second transistor M2 is connected to the first terminal N4 of the storage capacitor Cst. A gate of the drive transistor MD is connected to the second terminal N3 of the storage capacitor Cst. A gate of the third transistor M3 is connected to the second scanning terminal SCAN2, a first terminal of the third transistor M3 is connected to the gate N3 of the drive transistor MD, and a second terminal of the third transistor M3 is connected to a second terminal N2 of the drive transistor MD.

Optionally, the first reset module 105A includes a fourth transistor M4, and a gate of the fourth transistor M4 is connected to the third scanning terminal SCAN3.

Optionally, the light emission control module 106 includes a fifth transistor M5, and the second reset module 107 includes a sixth transistor M6. A gate of the fifth transistor M5 is connected to the dimming control terminal EMIT, a first terminal of the fifth transistor M5 is connected to the second terminal N2 of the drive module 102, and a second terminal of the fifth transistor M5 is connected to the first electrode Na of the light-emitting element 200. A gate of the sixth transistor M6 is connected to the reset control terminal VINI, a first terminal of the sixth transistor M6 is connected to the second reset signal terminal VRST, and a second terminal of the sixth transistor M6 is connected to the first electrode Na of the light-emitting element 200.

Optionally, the pixel circuit 100 includes at least two transistors, and both the transistors are PMOS transistors.

In this embodiment, the negative feedback module 101 includes the first transistor M1. Optionally, when the first transistor M1 is a p-type transistor, the first terminal (a source S) of the first transistor M1 is connected to the first power terminal VG1, and both the second terminal (a drain D) and the gate of the first transistor M1 are connected to the first terminal N1 of the drive transistor MD. When a potential of the first terminal N1 of the drive transistor MD is at a high level, the first transistor M1 is controlled to be turned off. When the potential of the first terminal N1 of the drive transistor MD is at a low level, the first transistor M1 is controlled to be turned on.

Optionally, when the drive transistor MD is a p-type transistor, the first terminal N1 (a source) of the drive transistor MD is connected to the drain of the first transistor M1, the second terminal N2 (a drain) of the drive transistor MD is connected to the first terminal of the fifth transistor M5, and the gate of the drive transistor MD is connected to the second terminal N3 of the storage capacitor Cst. When a potential of the gate N3 of the drive transistor MD is at a high level, the drive transistor MD is controlled to be turned off. When the potential of the gate N3 of the drive transistor MD is at a low level, the drive transistor MD is controlled to be turned on.

The data writing module 103 includes the second transistor M2. Optionally, when the second transistor M2 is a p-type transistor, the first terminal (a source) of the second transistor M2 is connected to the data signal terminal Vdata, the second terminal (a drain) of the second transistor M2 is connected to the first terminal N4 of the storage capacitor Cst, and the gate of the second transistor M2 is connected to the first scanning terminal SCAN1. The threshold compensation module 104 includes the third transistor M3. Optionally, when the third transistor M3 is a p-type transistor, the first terminal (a source) of the third transistor M3 is connected to the gate N3 of the drive transistor MD, the second terminal (a drain) of the third transistor M3 is connected to the second terminal N2 of the drive transistor MD, and the gate of the third transistor M3 is connected to the second scanning terminal SCAN2. Optionally, the first scanning terminal SCAN1 and the second scanning terminal SCAN2 are connected to the same scan signal line. When a potential of the first scanning terminal SCAN1 is at a high level, the second transistor M2 and the third transistor M3 are both controlled to be turned off. When the potential of the first scanning terminal SCAN1 is at a low level, the second transistor M2 and the third transistor M3 are both controlled to be turned on.

The first reset module 105A includes a fourth transistor M4A. Optionally, when the fourth transistor M4A is a p-type transistor, a first terminal (a source) of the fourth transistor M4A is connected to the first reset signal terminal Vref, a second terminal (a drain) of the fourth transistor M4A is connected to the first terminal N4 of the storage capacitor Cst, and the gate of the fourth transistor M4A is connected to the third scanning terminal SCAN3. When a potential of the third scanning terminal SCAN3 is at a high level, the fourth transistor M4A is controlled to be turned off. When the potential of the third scanning terminal SCAN3 is at a low level, the fourth transistor M4A is controlled to be turned on.

The light emission control module 106 includes the fifth transistor M5. Optionally, when the fifth transistor M5 is a p-type transistor, the first terminal (a source) of the fifth transistor M5 is connected to the drain of the drive transistor MD, the second terminal (a drain) of the fifth transistor M5 is connected to the first electrode Na of the light-emitting element 200, and the gate of the fifth transistor M5 is connected to the dimming control terminal EMIT. When a potential of the dimming control terminal EMIT is at a high level, the fifth transistor M5 is controlled to be turned off. When the potential of the dimming control terminal EMIT is at a low level, the fifth transistor M5 is controlled to be turned on.

The second reset module 107 includes the sixth transistor M6. Optionally, when the sixth transistor M6 is a p-type transistor, the first terminal (a source) of the sixth transistor M6 is connected to the second reset signal terminal VRST, the second terminal (a drain) of the sixth transistor M6 is connected to the first terminal Na of the light-emitting element 200, and the gate of the sixth transistor M6 is connected to the reset control terminal VINI. When a potential of the reset control terminal VINI is at a high level, the sixth transistor M6 is controlled to be turned off. When the potential of the reset control terminal VINI is at a low level, the sixth transistor M6 is controlled to be turned on.

It may be understood that the pixel circuit shown in FIG. 7 is a structure of only one of the pixel circuits of the present disclosure. The structure of the pixel circuit can be adjusted according to the requirement of a product. For example, the pixel circuit includes seven or more transistors, types of the transistors of the pixel circuit include PMOS transistors and N-channel metal oxide semiconductor (NMOS) transistors, or the types of the transistors of the pixel circuit are all NMOS transistors.

Optionally, at the threshold compensation stage, the light emission control module and the second reset module are turned off; at the light emission stage, the light emission control module is turned on, and the second reset module is turned off. Optionally, the pre-stage further includes the initialization stage. At the initialization stage, the drive module, the data writing module, the threshold compensation module, the light emission control module and the second reset module are turned on, and the negative feedback module is turned off. Optionally, the pre-stage further includes the pre-light emission stage. At the pre-light emission stage, the negative feedback module, the drive module, the light emission control module and the second reset module are turned on, and the data writing module and the threshold compensation module are turned off. Optionally, the pre-stage further includes the pre-light emission stage. At the pre-light emission stage, the first reset module is turned on.

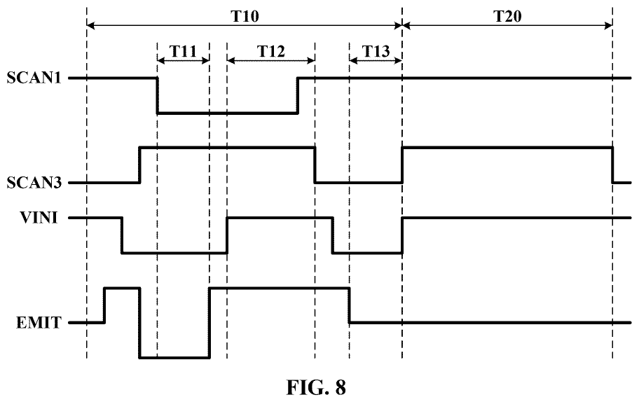

FIG. 8 is a timing diagram of the pixel circuit shown in FIG. 7. As shown in FIG. 8, the working process of the pixel circuit 100 includes at least a pre-stage T10 and a light emission stage T20. The pre-stage T10 includes an initialization stage T11, a threshold compensation stage T12 and a pre-light emission stage T13 that are performed in order. Referring to FIGS. 7 and 8, the working process of the pixel circuit 100 is described below.

At the initialization stage T11, the first scanning terminal SCAN1 provides a low-level signal turned on both the second transistor M2 and the third transistor M3; the third scanning terminal SCAN3 provides a high-level signal to turn off the fourth transistor M4A; the dimming control terminal EMIT provides a reference voltage signal to turn on the fifth transistor M5, where the reference voltage signal VBIAS is lower than a turn-on voltage of the fifth transistor M5; the reset control terminal VINI provides a low-level signal to turn on the sixth transistor M6, the drive transistor MD is turned on, the first transistor M1 is turned off, and thus a PVDD power signal of the source N1 of the drive transistor MD flows to the second reset signal terminal VRST. In this case, the potential of the node N4 is the reference potential V_{DATA}, and both the node N3 and the node N2 are at a relatively low potential. It is to be noted that at other stages except for the initialization stage, there is a case where the first transistor M1 is turned on. In this case, the PVDD power signal provided by the first power terminal VG1 is written to the first terminal N1 of the drive transistor MD.

At the threshold compensation stage T12, the first scanning terminal SCAN1 provides a low-level signal to turn on both the second transistor M2 and the third transistor M3; the third scanning terminal SCAN3 provides a high-level signal to turn off the fourth transistor M4A; the dimming control terminal EMIT provides a high-level signal to turn off the fifth transistor M5; the reset control terminal VINI provides a high-level signal to turn off the sixth transistor M6; and the drive transistor MD is turned on and the first transistor M1 is turned off. It is to be noted that at a later stage of the threshold compensation stage T12, the signal provided by the first scanning terminal SCAN1 is switched from a low level to a high level to turn off both the second transistor M2 and the third transistor M3. In conjunction with FIG. 2, after the signal provided by the first scanning terminal SCAN1 hops from a low level to a high level, the potential of the node N4 changes from V_{DATA} to (V_{DATA}+ΔVx), the potential of the node N3 changes from (V_{N1a}−Vₜₕₚ) to (V_{N1a}−Vₜₕₚ+ΔVx×Cst/(Cst+Cot)), and the potential of the node N3 is the same as the potential of the node N2.

At the pre-light emission stage T13, the first scanning terminal SCAN1 provides a high-level signal to turn off both the second transistor M2 and the third transistor M3; the third scanning terminal SCAN3 provides a low-level signal to turn on the fourth transistor M4A; the dimming control terminal EMIT provides a low-level signal to turn on the fifth transistor M5; the reset control terminal VINI provides a low-level signal to turn on the sixth transistor M6; and the drive transistor MD and the first transistor M1 are turned on. In this case, a reference voltage V_{REF} provided by the first reset signal terminal Vref is written to the node N4, that is, the potential of the node N4 is V_{REF}. The PVDD power signal provided by the first power terminal VG1 flows to the source of the sixth transistor M6, that is, the second reset signal terminal VRST, via the first transistor M1, the drive transistor MD and the fifth transistor M5. Based on these, the node N3 and the node N2 are stabilized to a voltage of a corresponding light emission drive signal (a grayscale current). For example, the potential of the node N3 is V_{N1a}−|Vₜₕₚ|−(V_{DATA}−V_{REF}+ΔVx)+ΔVx×Cst/(Cst+Cot), and the potential of the node N4 is V_{REF}. Finally, the potential of the node N3 is V_{N1a}−|Vₜₕₚ|−(V_{DATA}−V_{REF})−ΔVx×Cot/(Cst+Cot).

At the light emission stage T20, the first scanning terminal SCAN1 provides a high-level signal to turn off both the second transistor M2 and the third transistor M3; the third scanning terminal SCAN3 provides a high-level signal to turn off the fourth transistor M4A; the dimming control terminal EMIT provides a low-level signal to turn on the fifth transistor M5; the reset control terminal VINI provides a high-level signal to turn off the sixth transistor M6; and the drive transistor MD and the first transistor M1 are turned on. In this case, the transmission path between the first power terminal VG1 and the first electrode Na of the light-emitting element 200 is connected, and the PVDD power signal provided by the first power terminal VG1 flows to the first electrode Na of the light-emitting element 200 via the first transistor M1, the drive transistor MD and the fifth transistor M5 and flows from the first electrode Na of the light-emitting element 200 to the second power terminal VG2 to drive the light-emitting element 200 to emit light. Based on these, the light emission drive signal (the grayscale current) I_{OLED} is as follows:

$${I}_{OLED} = ( m - 1 ) \times μ {C}_{OX} \times \frac{{W}_{P}}{{L}_{P}} \times {{V}_{T}}^{2} \times {exp}^{Y} ,$$

$$Y = ( {V}_{N 1 b} - {V}_{N 1 a} + \vert {V}_{thp} \vert + ( {V}_{DATA} - {V}_{REF} ) + ( Δ Vx \times \frac{Cot}{Cst + Cot} ) - \vert {V}_{thp} \vert ) \times [ 1 - {exp}^{- \frac{{V}_{DS}}{{V}_{T}}} ] ;$$

Y is simplified as follows:

$$Y = ( Δ {V}_{N 1} + ( {V}_{DATA} - {V}_{REF} ) + ( Δ Vx \times \frac{Cot}{Cst + Cot} ) ) \times [ 1 - {exp}^{- \frac{{V}_{DS}}{{V}_{T}}} ] ;$$

since Cot is much less than Cst, ΔVx×Cot/(Cst+Cot) is approximately equal to 0, and I_{OLED} is as follows:

$${I}_{OLED} = ( m - 1 ) \times μ {C}_{OX} \times \frac{{W}_{P}}{{L}_{P}} \times {{V}_{T}}^{2} \times {exp}^{( Δ {V}_{N 1} + ( {V}_{DATA} - {V}_{REF} ) ) \times [ 1 - {exp}^{( - \frac{{V}_{DS}}{{V}_{T}} )} ]} .$$

V_{N1b} is a potential of the node N1 at a current stage, m is a mobility, μ is a carrier mobility of a PMOS transistor, C_{OX} is a capacitance of an oxide layer per unit area, W_{P}/L_{P} is a width-to-length ratio of the PMOS transistor, V_{T} is an absolute temperature coefficient, and V_{DS} is a voltage difference between a source and a drain of the PMOS transistor. In the above I_{OLED} formula, W_{P}/L_{P} may be understood as a width-to-length ratio of the drive transistor MD, and V_{DS} may be understood as a voltage difference between the source and the drain of the drive transistor MD.

As can be seen from the above I_{OLED} formula, the pixel circuit 100 shown in FIG. 7 weakens the effect of charge injection and reduces the difference between light emission drive signals (light emission currents) of the pixel circuit at the near end and the pixel circuit at the far end of the display panel. Then, the display panel using the pixel circuit 100 as described above has higher display uniformity and can weaken the effect of a current resistance (IR) drop of a power supply.

In addition, in this embodiment, the first transistor M1 playing a negative feedback role is added to the pixel circuit 100, thereby effectively suppressing a difference between light emission currents of pixel circuits 100 at different positions in the display panel and further improving the display uniformity.

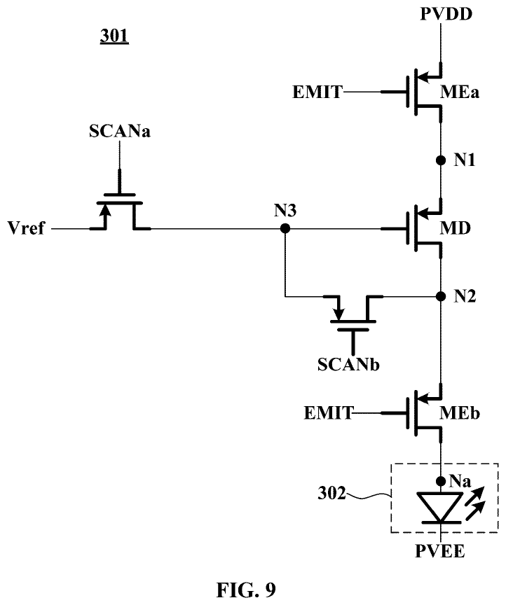

FIG. 9 is a schematic diagram of a conventional pixel circuit. As shown in FIG. 9, a pixel circuit 301 is connected to a light-emitting element 302. A cathode of the light-emitting element 302 is connected to a PVEE power signal terminal, an anode Na of the light-emitting element 302 is connected to a second terminal N2 of a drive transistor MD via a second dimming transistor MEb, and a first terminal N1 of a drive transistor MD is connected to a PVDD power signal terminal via a first dimming transistor MEa. A resistance of the cathode of the light-emitting element 302 is relatively large, and resistances of cathodes of light-emitting elements 302 at different positions in the display panel are non-uniform. Based on these, at a light emission stage, as light-emitting elements 302 at different positions have different grayscales, non-uniform resistances of cathodes of the light-emitting elements 302 cause fluctuations in PVEE power signals of PVEE power signal terminals of pixel circuits 301 at different positions, the fluctuations in the PVEE power signals drive voltages of nodes N2 to fluctuate, and fluctuations in source-drain voltages V_{DS} of drive transistors MD are caused. It is to be noted that many factors cause a fluctuation in a voltage of the second terminal N2 of the drive transistor MD in the display process of the display panel. Here, only the case where the fluctuation in PVEE causes the fluctuation of the node N2 of the drive transistor MD is used as an example for description. At present, display panels are mostly made by using silicon-based substrates, and in silicon-based display panels, especially silicon-based OLED display panels, drive transistors MD mostly work in subthreshold regions. Therefore, when the source-drain voltage V_{DS} of the drive transistor MD fluctuates, a light emission drive signal (a light emission current) provided by the pixel circuit 301 to the light-emitting element 302 at the light emission stage is also affected and fluctuates, resulting in a change in display brightness and poorer display uniformity of the display panel. The light emission current is also a grayscale current.

In this embodiment, the first transistor M1 is added to the pixel circuit 100, thereby solving the problem of poor display uniformity caused by the fluctuation in the PVEE power signal.

In an embodiment, when the PVEE power signal is increased, the potential of the node N2 is also increased. Therefore, the light emission drive signal, that is, the light emission current I_{OLED}, provided by the drive transistor MD to the light-emitting element 200 is decreased. When I_{OLED} is decreased, the first transistor M1 drives a potential V_{N1} of the node N1 to increase to adapt to the light emission current at this time. In this case, a gate-source voltage Vos of the drive transistor MD is increased so that the light emission current generated by the drive transistor MD is increased. Therefore, the decrease drift of I_{OLED} caused by the fluctuation in PVEE can be pulled back up to an original value, and the display of the light-emitting element 200 is restored to the same brightness.

When the PVEE power signal is decreased, the potential of the node N2 is also decreased. Therefore, I_{OLED} is increased. When I_{OLED} is increased, the first transistor M1 drives the potential V_{N1} of the node N1 to decrease to adapt to the light emission current at this time. In this case, the gate-source voltage Vos of the drive transistor MD is decreased so that the light emission current generated by the drive transistor MD is decreased. Therefore, the increased I_{OLED} can be pulled back down to the original value, and the display of the light-emitting element 200 is restored to the same brightness.

The first transistor M1 in the pixel circuit 100 can effectively suppressing a difference in a pixel current caused by the fluctuation in PVEE, thereby further improving the display uniformity.

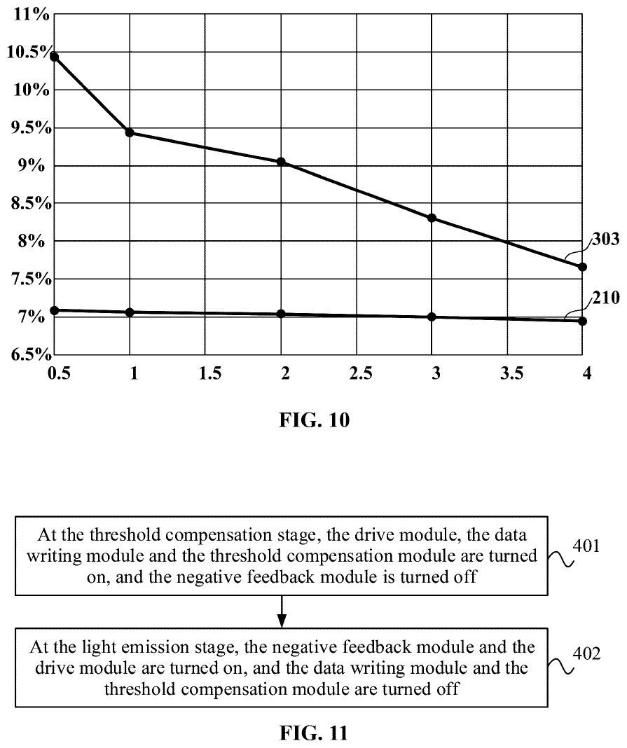

FIG. 10 is a schematic diagram illustrating the simulation results of two different pixel circuits. As shown in FIG. 10, an abscissa represents a grayscale, an ordinate represents a display offset noise, a curve 303 illustrates simulation results obtained after simulation based on the pixel circuit 301 shown in FIG. 9, and a curve 210 illustrates simulation results obtained after simulation based on the pixel circuit 100 shown in FIG. 7. When V_{DATA}=0.1 V, a low grayscale is displayed, and when V_{DATA}=0.8 V, a high grayscale is displayed.

As shown in FIG. 10, according to the curve 303, an offset noise of the existing pixel circuit 301 is gradually increased with the decrease of the grayscale, that is, the display non-uniformity of medium and low grayscales is higher and easier to be captured by eyes. Therefore, an existing display panel has relatively poor display uniformity.

The simulation result of the pixel circuit 100 of this embodiment, that is, an offset noise of the curve 210, is lower than the offset noise of the existing pixel circuit 301. For example, according to the curve 210, the difference between offset noises of the pixel circuit 100 at different grayscales is very small, and an offset noise at each grayscale is basically consistent. Therefore, a display panel based on the pixel circuit 100 has high display uniformity.

Based on the same inventive concept, embodiments of the present disclosure further provide a driving method of a pixel circuit. The driving method is applied to the pixel circuit described in any one of the preceding embodiments and has the corresponding beneficial effects of the pixel circuit described in any one of the preceding embodiments. The driving method of this embodiment may be performed by a driving device, and the driving device may be implemented in the form of hardware and/or software and may be configured in a display device. A working process of the pixel circuit includes at least a pre-stage and a light emission stage, and the pre-stage includes a threshold compensation stage.

FIG. 11 illustrates a driving method of a pixel circuit according to an embodiment of the present disclosure. As shown in FIG. 11, the driving method includes the steps described below.

In step 401, at the threshold compensation stage, the drive module, the data writing module and the threshold compensation module are turned on, and the negative feedback module is turned off.

In step 402, at the light emission stage, the negative feedback module and the drive module are turned on, and the data writing module and the threshold compensation module are turned off.

In the present disclosure, the pixel circuit includes the negative feedback module and one storage capacitor. The negative feedback module is connected between the first power terminal and the first terminal of the drive module, and the control terminal of the negative feedback module is connected to the first terminal of the drive module. The first terminal of the storage capacitor is connected to the data writing module, and the second terminal of the storage capacitor is connected to the control terminal of the drive module. At the threshold compensation stage, the negative feedback module is turned off. At the light emission stage, the data writing module and the threshold compensation module are turned off. In the present disclosure, the pixel circuit includes only one storage capacitor. Therefore, a relatively small size of the pixel circuit is conducive to improving the resolution and applicable to making the high-resolution display panel. At the threshold compensation stage, the control terminal and the second terminal of the drive module simultaneously act so that the effect of charge injection can be weakened and the threshold voltage of the drive transistor of the pixel circuit can be closer to the actual threshold voltage, thereby effectively implementing the threshold voltage compensation function. At the light emission stage, both the first terminal and the second terminal of the storage capacitor are at the fixed potential and not susceptible to the noise. The negative feedback module has the effect of suppressing the current change caused by the voltage fluctuation. Based on these, the display uniformity can be effectively improved.

Based on the same inventive concept, embodiments of the present disclosure further provide a display panel. The display panel includes the pixel circuit described in any one of the preceding embodiments. Optionally, the display panel includes an organic light-emitting display panel. The display panel has the corresponding function modules and beneficial effects of the pixel circuit described in any one of the preceding embodiments.

In this embodiment, the display panel may be a smartphone. However, the display panel is not limited to a terminal device such as a mobile phone, a tablet computer, a notebook computer, an ultra-mobile personal computer, a netbook, a smart wearable device, an in-vehicle device or an augmented reality (AR)/virtual reality (VR) device. The display panel may be, but is not limited to, an organic light-emitting display panel.

It is to be understood that various forms of the preceding flows may be used with steps reordered, added, or deleted. For example, the steps described in the present disclosure may be performed in parallel, in sequence, or in a different order as long as the desired result of the technical solutions provided in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, or improvement made within the spirit and principle of the present disclosure falls within the scope of the present disclosure.

What is claimed is:

1. A pixel circuit, comprising a negative feedback module, a drive module, a data writing module, a threshold compensation module and a storage capacitor;
wherein the negative feedback module is connected between a first power terminal and a first terminal of the drive module, and a control terminal of the negative feedback module is connected to the first terminal of the drive module;
a second terminal of the drive module is connected to a light-emitting element for providing a light emission drive signal to the light-emitting element, and the drive module comprises a drive transistor;
the data writing module is connected between a data signal terminal and a first terminal of the storage capacitor, a control terminal of the data writing module is connected to a first scanning terminal, and a second terminal of the storage capacitor is connected to a control terminal of the drive module;
the threshold compensation module is connected between the control terminal of the drive module and a second terminal of the drive module, and a control terminal of the threshold compensation module is connected to a second scanning terminal;
a working process of the pixel circuit comprises at least a pre-stage and a light emission stage, and the pre-stage comprises a threshold compensation stage;
at the threshold compensation stage, the drive module, the data writing module and the threshold compensation module are turned on, and the negative feedback module is turned off; and
at the light emission stage, the negative feedback module and the drive module are turned on, and the data writing module and the threshold compensation module are turned off.

2. The pixel circuit according to claim 1, wherein the first scanning terminal and the second scanning terminal are connected to a same scan signal line.

3. The pixel circuit according to claim 1, wherein the negative feedback module comprises a first transistor, the data writing module comprises a second transistor, and the threshold compensation module comprises a third transistor;
a first terminal of the first transistor is connected to the first power terminal, and a gate of the first transistor and a second terminal of the first transistor are both connected to a first terminal of the drive transistor;
a gate of the second transistor is connected to the first scanning terminal, a first terminal of the second transistor is connected to the data signal terminal, and a second terminal of the second transistor is connected to the first terminal of the storage capacitor;
a gate of the drive transistor is connected to the second terminal of the storage capacitor; and
a gate of the third transistor is connected to the second scanning terminal, a first terminal of the third transistor is connected to the gate of the drive transistor, and a second terminal of the third transistor is connected to a second terminal of the drive transistor.

4. The pixel circuit according to claim 1, further comprising a first reset module;
wherein the first reset module is connected between a first reset signal terminal and the first terminal of the storage capacitor, and a control terminal of the first reset module is connected to a third scanning terminal.

5. The pixel circuit according to claim 1, further comprising a first reset module;
wherein the first reset module is connected between a first reset signal terminal and the second terminal of the drive module, and a control terminal of the first reset module is connected to a third scanning terminal.

6. The pixel circuit according to claim 4, wherein the first reset module comprises a fourth transistor; and
a gate of the fourth transistor is connected to the third scanning terminal.

7. The pixel circuit according to claim 5, wherein the first reset module comprises a fourth transistor; and
a gate of the fourth transistor is connected to the third scanning terminal.

8. The pixel circuit according to claim 1, further comprising a light emission control module and a second reset module;
the light emission control module is connected between the second terminal of the drive module and a first electrode of the light-emitting element, and a control terminal of the light emission control module is connected to a dimming control terminal; and
the second reset module is connected between a second reset signal terminal and the first electrode of the light-emitting element, and a control terminal of the second reset module is connected to a reset control terminal.

9. The pixel circuit according to claim 8, wherein the light emission control module comprises a fifth transistor, and the second reset module comprises a sixth transistor;
a gate of the fifth transistor is connected to the dimming control terminal, a first terminal of the fifth transistor is connected to the second terminal of the drive module, and a second terminal of the fifth transistor is connected to the first electrode of the light-emitting element; and
a gate of the sixth transistor is connected to the reset control terminal, a first terminal of the sixth transistor is connected to the second reset signal terminal, and a second terminal of the sixth transistor is connected to the first electrode of the light-emitting element.

10. The pixel circuit according to claim 1, comprising at least two transistors, wherein the at least two transistors each are P-channel metal oxide semiconductor (PMOS) transistors.

11. The pixel circuit according to claim 8, wherein at the threshold compensation stage, the light emission control module and the second reset module are turned off; and
at the light emission stage, the light emission control module is turned on, and the second reset module is turned off.

12. The pixel circuit according to claim 8, wherein the pre-stage further comprises an initialization stage; and
at the initialization stage, the drive module, the data writing module, the threshold compensation module, the light emission control module and the second reset module are turned on, and the negative feedback module is turned off.

13. The pixel circuit according to claim 8, wherein the pre-stage further comprises a pre-light emission stage; and
at the pre-light emission stage, the negative feedback module, the drive module, the light emission control module and the second reset module are turned on, and the data writing module and the threshold compensation module are turned off.

14. The pixel circuit according to claim 4, wherein the pre-stage further comprises a pre-light emission stage; and
at the pre-light emission stage, the first reset module is turned on.

15. The pixel circuit according to claim 5, wherein the pre-stage further comprises a pre-light emission stage; and
at the pre-light emission stage, the first reset module is turned on.

16. A driving method of a pixel circuit, wherein the pixel circuit comprises a negative feedback module, a drive module, a data writing module, a threshold compensation module and a storage capacitor; wherein the negative feedback module is connected between a first power terminal and a first terminal of the drive module, and a control terminal of the negative feedback module is connected to the first terminal of the drive module; a second terminal of the drive module is connected to a light-emitting element for providing a light emission drive signal to the light-emitting element, and the drive module comprises a drive transistor; the data writing module is connected between a data signal terminal and a first terminal of the storage capacitor, a control terminal of the data writing module is connected to a first scanning terminal, and a second terminal of the storage capacitor is connected to a control terminal of the drive module; the threshold compensation module is connected between the control terminal of the drive module and a second terminal of the drive module, and a control terminal of the threshold compensation module is connected to a second scanning terminal; a working process of the pixel circuit comprises at least a pre-stage and a light emission stage, and the pre-stage comprises a threshold compensation stage; at the threshold compensation stage, the drive module, the data writing module and the threshold compensation module are turned on, and the negative feedback module is turned off; and at the light emission stage, the negative feedback module and the drive module are turned on, and the data writing module and the threshold compensation module are turned off; and wherein the working process of the pixel circuit comprises at least the pre-stage and the light emission stage, and the pre-stage comprises the threshold compensation stage; and
the driving method comprises:
at the threshold compensation stage, the drive module, the data writing module and the threshold compensation module are turned on, and the negative feedback module is turned off; and
at the light emission stage, the negative feedback module and the drive module are turned on, and the data writing module and the threshold compensation module are turned off.

17. A display panel, comprising a pixel circuit, wherein the pixel circuit comprises a negative feedback module, a drive module, a data writing module, a threshold compensation module and a storage capacitor;
wherein the negative feedback module is connected between a first power terminal and a first terminal of the drive module, and a control terminal of the negative feedback module is connected to the first terminal of the drive module;
a second terminal of the drive module is connected to a light-emitting element for providing a light emission drive signal to the light-emitting element, and the drive module comprises a drive transistor;
the data writing module is connected between a data signal terminal and a first terminal of the storage capacitor, a control terminal of the data writing module is connected to a first scanning terminal, and a second terminal of the storage capacitor is connected to a control terminal of the drive module;
the threshold compensation module is connected between the control terminal of the drive module and a second terminal of the drive module, and a control terminal of the threshold compensation module is connected to a second scanning terminal;
a working process of the pixel circuit comprises at least a pre-stage and a light emission stage, and the pre-stage comprises a threshold compensation stage;
at the threshold compensation stage, the drive module, the data writing module and the threshold compensation module are turned on, and the negative feedback module is turned off, and
at the light emission stage, the negative feedback module and the drive module are turned on, and the data writing module and the threshold compensation module are turned off.

18. The display panel according to claim 17, wherein the first scanning terminal and the second scanning terminal are connected to a same scan signal line.

19. The display panel according to claim 17, wherein the negative feedback module comprises a first transistor, the data writing module comprises a second transistor, and the threshold compensation module comprises a third transistor;
a first terminal of the first transistor is connected to the first power terminal, and a gate of the first transistor and a second terminal of the first transistor are both connected to a first terminal of the drive transistor;
a gate of the second transistor is connected to the first scanning terminal, a first terminal of the second transistor is connected to the data signal terminal, and a second terminal of the second transistor is connected to the first terminal of the storage capacitor;
a gate of the drive transistor is connected to the second terminal of the storage capacitor; and
a gate of the third transistor is connected to the second scanning terminal, a first terminal of the third transistor is connected to the gate of the drive transistor, and a second terminal of the third transistor is connected to a second terminal of the drive transistor.

20. The display panel according to claim 17, comprising an organic light-emitting display panel.
